(19) United States
(12) Patent Application Publication
(10) Pub. No.: US 2025/0061816 A1
(43) Pub. Date: Feb. 20, 2025

(54) Practice Vinyl Covering For Car Wraps

(71) Applicant: Eriberto Blanco, Corona, CA (US)

(72) Inventor: Eriberto Blanco, Corona, CA (US)

(21) Appl. No.: 18/235,837

(22) Filed: Aug. 19, 2023

(51) Int. Cl. G09B 19/00

(52) U.S. Cl. CPC G09B 19/00

(57) ABSTRACT

A vinyl car wrap material without the adhesive backing of a traditional car wrap. The vinyl is clear with a printed grid pattern with special point markings to teach a new student how to stretch vinyl around the contours of the vehicle being wrapped. The vinyl is designed to help new students of the trade to learn how to apply car wraps without wasting material.

### PRIOR ART

While vinyl wraps are well known in the prior art, the prior art is not designed to teach new students of the trade how to apply vinyl wraps on vehicles.

### BACKGROUND OF THE INVENTION

Applying a vinyl wrap to a vehicle is a precise and time-consuming task which requires a significant amount of materials to practice and master. Using new material on a vehicle until a student of the trade becomes proficient can be costly to a business. The present subject matter allows a new student to practice the trade of a vinyl wrap to a vehicle without having to waste materials.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non- permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter comprises of vinyl without the adhesive backing of a traditional car wrap. The vinyl is clear with a printed grid pattern with special point markings to teach a new student how to stretch vinyl around the contours of the vehicle being wrapped.

The grid pattern comprises of a plurality of half inch squares. The embodiment pictured in FIG. 1 is a 24 by 24 inch square grid, however, the size of the vinyl grid may be adjusted to suit practicing different vinyl wrap jobs.

The lack of adhesive backing allows for the user to learn the characteristics of the vinyl without interference from the adhesive backing of traditional car wraps. The clear vinyl also allows the student learning the trade to see through the vinyl and observe the vehicle the vinyl is being installed on. The grid pattern allows the student to see and calculate where and how much to stretch the vinyl around the vehicle and relies on electrostatic properties between the vehicle and the vinyl to stay on the car as opposed to relying on adhesive.

This allows the student to reuse the same piece of vinyl for practice until the skill has been sufficiently developed to install a traditional vinyl car wrap.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

### DESCRIPTION OF DRAWINGS

FIG. 1 shows a front view of the practice vinyl covering for car wraps.

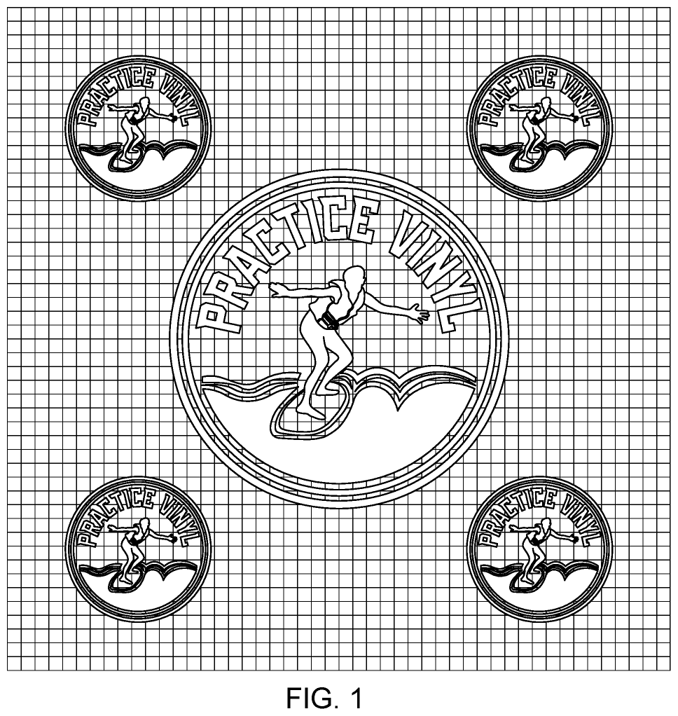

FIG. 2 shows a perspective view of a side mirror with the practice vinyl covering on the mirror.

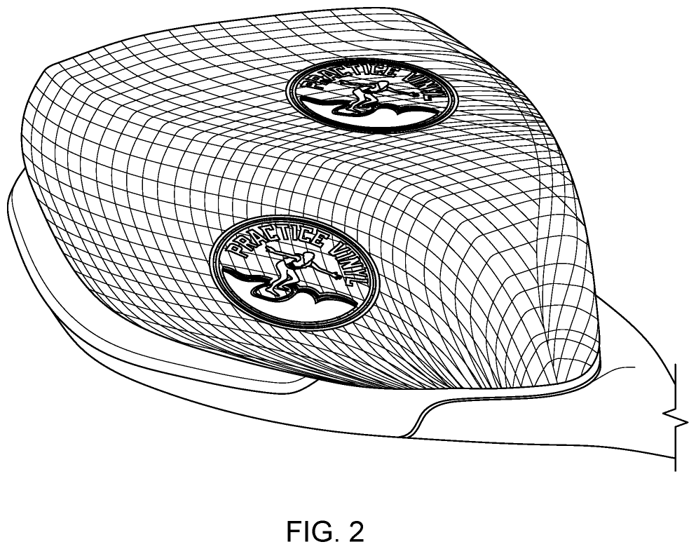

1. A vinyl car wrap material designed to teach new students how to apply car wraps comprising of a clear vinyl without adhesive.

2. The vinyl car wrap material designed to teach new students how to apply car wraps comprising of the clear vinyl without adhesive as in claim 1, wherein the clear vinyl has a grid pattern.

3. The vinyl car wrap material designed to teach new students how to apply car wraps comprising of the clear vinyl without adhesive as in claim 1, wherein the clear vinyl has special point markings to teach a student how to properly stretch the vinyl around the contours of a vehicle.

4. The vinyl car wrap material designed to teach new students how to apply car wraps comprising of the clear vinyl without adhesive as in claim 1, wherein the lack of adhesive allows for the student to reuse the vinyl until proficiency has been established.

5. The vinyl car wrap material designed to teach new students how to apply car wraps comprising of the clear vinyl without adhesive as in claim 1, wherein the transparency of the vinyl material allows the student to see the vehicle behind the wrap and get a better understanding of how the vinyl wraps around the vehicle.

6. The vinyl car wrap material designed to teach new students how to apply car wraps comprising of the clear vinyl without adhesive as in claim 1, wherein static electricity between the vehicle and the vinyl car wrap material is what holds the vinyl in place while proficiency in the trade is established.
